(19) United States
(12) Patent Application Publication
(10) Pub. No.: US 2021/0365995 A1
(43) Pub. Date: Nov. 25, 2021

(54) ADVERTISEMENT AND REWARD SYSTEM BASED ON INSTANT MESSENGER

(71) Applicant: Cryptorizen.co, Seoul (KR)

(72) Inventor: Hee Hyang IM, Seoul (KR)

(21) Appl. No.: 16/347,356

(22) PCT Filed: Apr. 3, 2019
(86) PCT No.: PCT/KR2019/003914

§ 371 Date: May 3, 2019

(30) Foreign Application Priority Data
Jan. 30, 2019 (KR) 10-2019-0012173
Jan. 30, 2019 (KR) 10-2019-0012182

(51) Int. Cl. G06Q 30/02; G06Q 20/38; H04L 12/58

(52) U.S. Cl. CPC G06Q 30/0273; G06Q 30/0277; G06Q 20/389; H04L 51/16; G06Q 30/0272; H04L 51/046; G06Q 30/0255

(57) ABSTRACT

An advertisement and reward system based on an instant messenger having a first user terminal configured to transmit a message to a second user terminal side on the instant messenger. The message is transmitted under a control of a messenger advertisement providing server and includes an advertisement; the second user terminal configured to receive the message including the advertisement from the first user terminal, and perform the advertisement included in the received message; and the messenger advertisement providing server configured to control the first user terminal so as to transmit the message created in the first user terminal with the advertisement included therein, and if it is confirmed that the advertisement has been executed, provide a reward to at least one of the first user terminal and the second user terminal. The reward may include a blockchain-based cryptocurrency.

### TECHNICAL FIELD

The present invention relates to an advertisement and reward system based on an instant messenger. More particularly, the present invention relates to a system for providing reward advertisements through chat messages transmitted and received on an instant messenger.

### BACKGROUND ART

An application for rewarding online viewing of advertisements, or action of installing a certain software refers to a reward application. Recently, a usage rate of these reward applications is increasing. Points accumulated through these applications may be used to buy a gifticon or gift certificate, and points accumulated over a certain level may be converted to cash.

However, in order to make a certain amount of money with the reward application, a lot of user's effort should be required. In a case of a reward application, a user needs to collect points of at least 30,000 Won or more in order to convert the points to cash. For this purpose, the user needs to look at 100 advertisements. An advertisement that gives a lot of points at one time involves cumbersome procedures such as registering as a member on a specific company homepage.

In a case of reward advertisements using these reward applications, there are many opinions that the advertisement effect is not great although the number of times of exposing the advertisement is high. The reason is that the user frequently executes an advertisement to obtain a point and does not properly view the advertisement.

### SUMMARY OF INVENTION

### Problems to be Solved by Invention

It is an object of the present invention to provide an advertisement and reward system based on an instant messenger capable of reducing adverse effects of only receiving a reward which is given as a price for viewing an advertisement without properly viewing the advertisement in reward advertisements, and increasing the probability that the advertisement leads to an actual purchase.

### Means for Solving Problems

According to an aspect of the present invention, there is provided an advertisement and reward system based on an instant messenger, the system including: a first user terminal configured to transmit a message to a second user terminal side on the instant messenger, wherein the message is transmitted under a control of a messenger advertisement providing server and includes an advertisement; the second user terminal configured to receive the message including the advertisement from the first user terminal, and perform the advertisement included in the received message; and the messenger advertisement providing server configured to control the first user terminal so as to transmit the message created in the first user terminal with the advertisement included therein, and if it is confirmed that the advertisement has been executed, provide a reward to at least one of the first user terminal and the second user terminal, wherein the reward includes a blockchain-based cryptocurrency.

### Advantageous Effects

According to the present invention, by diversifying the reward providing method, it is possible to minimize adverse effects caused by a cherry picker who receives a reward without properly viewing the advertisement.

According to the present invention, when providing reward advertisements, it is possible to smoothly transmit advertisements during performing chats on user instant messengers, and thereby confirm the advertisements and receive rewards in a simple manner without performing an operation such as performing a separate application.

In addition, according to the present invention, it is possible to analyze the chats performed on the instant messengers, extract interests of the user corresponding to the chats, and provide advertisements related to the interests of the user, thereby increasing the probability that the advertisements lead to an actual purchase.

Further, according to the present invention, it is possible to provide various types of rewards including blockchain-based cryptocurrency, and thereby reducing resistance of users for the advertisements on the instant messengers.

### BRIEF DESCRIPTION OF DRAWINGS

FIG. 1 is a block diagram for describing operations of providing reward advertisement contents according to an embodiment of the present invention;

FIG. 2 is a block diagram illustrating a configuration of a messenger advertisement providing server according to the embodiment of the present invention;

FIG. 3 is a block diagram illustrating a configuration of an optimal advertisement selection unit according to the embodiment of the present invention;

FIG. 4 is a block diagram illustrating a detailed configuration of the reward management unit according to the embodiment of the present invention;

FIG. 5 is a diagram illustrating chat windows of a reward advertisement performed on instant messengers according to the embodiment of the present invention;

FIG. 6 is a flowchart illustrating a procedure of advertisement and reward providing operations according to the embodiment of the present invention; and

FIG. 7 is a diagram illustrating an operation of providing a reward according to the embodiment of the present invention.

### MODE FOR CARRYING OUT INVENTION

The present invention may be altered in various ways and have various embodiments, and will be described with reference to the drawings for illustrating specific embodiments.

However, the present invention is not limited to the specific embodiments, and it will be understood by those skilled in the art that the present invention is to cover all modifications, equivalents, and alternatives falling within the spirit and scope of the present invention. Referring to the drawings, wherein like reference characters designate like or corresponding parts throughout the several views.

It will be understood that when a component is referred to as being “connected to” or “coupled to” another component, it may be directly connected or coupled to the other component intervening another component may be present. In contrast, when a component is referred to as being “directly connected to” or “directly coupled to” another component, there is no intervening component present.

In addition, the terminology used herein is for the purpose of describing particular embodiments only and is not intended to limit the present invention thereto. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

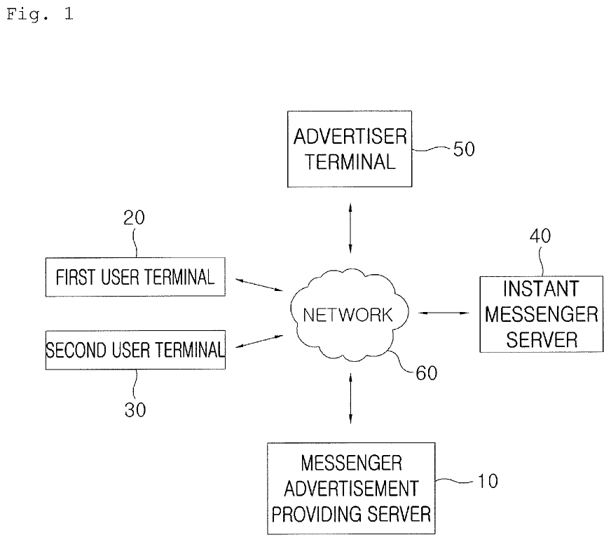

FIG. 1 is a block diagram for describing operations of providing reward advertisement contents according to an embodiment of the present invention

The advertisement and reward system according to the embodiment of the present invention may include a messenger advertisement providing server 10, a first user terminal 20, and a second user terminal 30. The advertisement and reward system may further include an instant messenger server 40 and an advertiser terminal 50 according to various embodiments.

Hereinafter, in this disclosure, a first user means a user on a side that transmits advertisement contents using the instant messenger, and a second user means a user on a side that receives advertisement contents using the instant messenger.

First, the messenger advertisement providing server according to the embodiment of the present invention performs an operation of transmitting the advertisement contents provided by advertisement company terminals 50 with being included in a message which is transmitted to the second user terminal 30 by the first user terminal 20.

Specifically, the messenger advertisement providing server 10 may monitor an operation of transmitting the message to the second user terminal 30 by the first user terminal 20 on the instant messenger supported by the instant messenger server 40. As a result of monitoring, when satisfying a preset condition (e.g., satisfying a condition of the number of times of message transmission/reception, or the like), the messenger advertisement providing server 10 may control the first user terminal 20 so that the advertisement is included in the message when transmitting the message to the second user terminal 30 by the first user terminal 20 through the instant messenger.

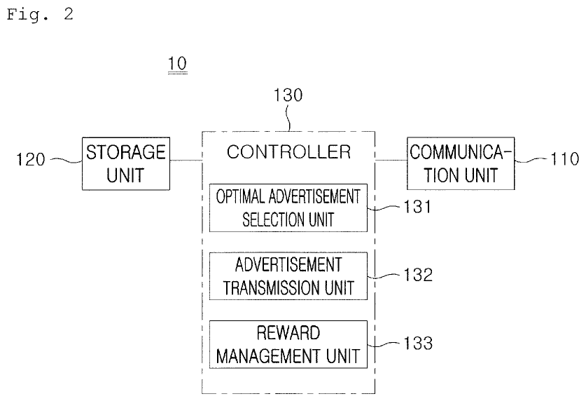

Next, the messenger advertisement providing server 10 will be described in more detail with reference to FIG. 2 below.

FIG. 2 is a block diagram illustrating a configuration of the messenger advertisement providing server according to the embodiment of the present invention.

As illustrated in FIG. 2, the messenger advertisement providing server 10 according to the embodiment of the present invention may include a communication unit 110, a storage unit 120, and a controller 130. In addition, the controller 130 may include an optimal advertisement selection unit 131, an advertisement transmission unit 132, and a reward management unit 133.

First, the communication unit 110 may use a network 60 for transmitting/receiving data between user devices and a server, and a type of the network is not particularly limited.

The communication unit 110 according to the embodiment of the present invention may transmit a control command, which is required for transmitting the advertisement to the second user terminal through the first user terminal 20, to the first user terminal 20. In addition, the communication unit 110 may perform an operation of obtaining a chat history between the first user and the second user, and an operation of receiving preference information, interest information of the users, and the like, which are input by the users.

The storage unit 120 may include, for example, an internal memory or an external memory.

The storage unit 120 according to the embodiment of the present invention may store data required for determining a user's interest based on the chat history performed on the instant messenger. For example, the storage unit 120 may store data required for determining an area to which words extracted from the chat history belongs.

In addition, the storage unit 120 may store various advertisement contents (advertisement moving picture, advertisement image, etc.) received from the advertisement company terminal 50.

The controller 130 may also be referred to as a processor, a control unit, a microcontroller, a microprocessor, a microcomputer or the like. Meanwhile, the controller may be implemented by hardware, firmware or software, or a combination thereof.

When implementing by firmware or software, the controller according to the embodiment of the present invention may be implemented in a form of a module, a procedure, a function, or the like that performs the functions or operations described above. Software codes may be stored in a memory and driven by the controller. The memory may be located inside or outside the user terminal and the server, and may send and receive data to and from the controller by various means previously known in the art.

The controller 130 according to the embodiment of the present invention may include an optimal advertisement selection unit 131, an advertisement transmission unit 132, and a reward management unit 133.

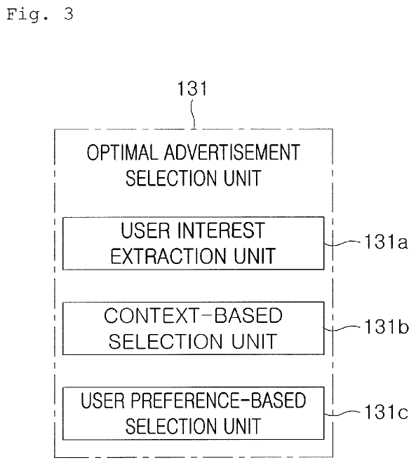

The optimal advertisement selection unit 131 may perform an operation of selecting a type of advertisement suitable for providing through the first user among various types of advertisement contents that can be provided by the messenger advertisement providing server 10 (e.g., an operation of selecting an optimal advertisement item). The optimal advertisement selection unit 131 will be described in more detail with reference to FIG. 3 below.

The advertisement transmission unit 132 may perform an operation of transmitting the advertisement contents selected by the optimal advertisement selection unit on the instant messenger together with the message which is transmitted to the other users by the first user. The advertisement transmission unit 132 may select a time point at which the advertisement content is transmitted on the instant messenger. The advertisement transmission unit 132 may set a condition for transmitting the advertisement contents, and may control so as to transmit the message with the advertisement included therein, when satisfying the condition such as the cumulative number of chat messages in a day, the reference time elapsed from the chat start time, and the reference time elapsed from the chat stop time. According to various embodiments, the advertisement transmission unit 132 may control so as to transmit the message with the advertisement included therein, in all cases of transmitting the messages to the second user by the first user.

Further, the advertisement transmission unit 132 may temporarily or permanently limit the transmission of the advertisement contents according to the characteristics of the second user who receives the advertisement contents (e.g., a user who does not agree to receive the reward advertisement, a user who has limited the advertisement transmission designated by the first user, etc.).

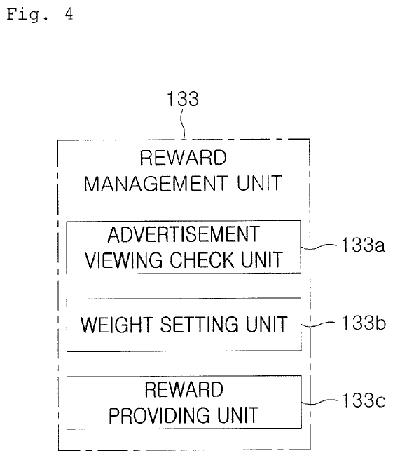

The reward management unit 133 may provide a reward to at least one of the first user and the second user as the advertisement content is transmitted from the first user to the second user. At this time, the reward may include a blockchain-based cryptocurrency. The reward management unit 133 will be described in more detail with reference to FIG. 4 below.

FIG. 3 is a block diagram illustrating a configuration of the optimal advertisement selection unit according to the embodiment of the present invention.

As illustrated in FIG. 3, the optimal advertisement selection unit 131 according to the embodiment of the present invention may include a user interest extraction unit 131a, a context-based selection unit 131b, and a user preference-based selection unit 131c.

First, the user interest extraction unit 131a may collect interest information of the first user in advance according to various embodiments of the present invention. For example, the user interest extraction unit 131a may request the first user to input an area of interest, or may provide a selection menu so as to select the area of interest. For example, the user interest extraction unit 131a may provide classification items such as ‘travel,’ ‘clothing,’ ‘beauty,’ ‘electronic device,’ and ‘cultural life’ to the user so as to request the user to select his/her interest item. When the interest items are set from the user, the user interest extraction unit 131a may store and manage an account of the user and the interest items thereof by matching with each other.

According to various embodiments, the user interest extraction unit 131a may perform an operation of extracting an area of interests based on the chat history of the user.

The user interest extraction unit 131a may calculate the area of interests of the first user who serve to provide the advertisement. The user interest extraction unit 131a may calculate the interests of the first user based on words included in the chat history, the number of times of inputting a specific word and the like. According to various embodiments, among the preset interest area items, the user interest extraction unit 131a may calculate the interests of the first user, as well as may respectively calculate the interests of chat participants, and thereby may calculate common interests of the chat participants. a user interest extraction unit 131a may also determine a ranking of the interests of the user in descending order from a field having the largest number of the words contained in the message.

The area of interest may be previously set as a large classification item such as, for example, ‘travel,’ ‘clothing,’ ‘beauty,’ ‘electronic device,’ or ‘cultural life.’ After extracting the words included in the chat history, when properties of the extracted words are words included in a small classification item, it is possible to calculate words of a middle classification or a large classification including the extracted words, and classify the words based on the calculated results. The user interest extraction unit 131 may extract the interests of the first user or the common interests of the chat participants based on the chat history. For example, when the word ‘leggings’ is obtained in the chat history, the user interest extraction unit 131 may classify the word ‘leggings’ into a ‘clothing’ item which is an upper level classification item.

The user interest extraction unit 131 may determine the area of the large classification item in which the largest number of words is secured through the item classification operation of the words as an area of user's interest. For example, the user interest extraction unit 131 performs an operation of extracting and classifying the words based on the chat history of the user, and as a result thereof, if it is assumed that result values are calculated as one (1) in the travel item, ten (10) in the clothing item, two (2) in the beauty item, and zero (0) in the electronic device and cultural life item, the user interest extraction unit 131 may determine that the interest of the user is the ‘clothing’ item.

The user interest extraction unit 131a may select the advertisement items and the advertisement contents corresponding to the interests of the first user. For example, if the interest of the first user is ‘clothing’ item, the user interest extraction unit 131a may preferentially select and provide the clothing-related advertisement. Accordingly, the present invention may provide the advertisement contents to the second user who receives the message, and may simultaneously advertise articles to the first user who transmits the message. Further, the present invention analyzes the interest of the first user and then advertises the articles corresponding to the interests of the first user, such that it is possible to encourage the first user to make purchases. In addition, the present invention transmits article advertisements related to the area of interests of the first user on a message of the first user, such that an effect such as promoting a specific article by a related area specialist may be expected.

The user interest extraction unit 131a may comprehensively analyze the chat history in various chat windows, as well as the chat history with a specific subject to calculate the interests of the first user.

The context-based selection unit 131b may perform an operation of selecting the article advertisements associated with a chat topic. Specifically, the context-based selection unit 131b may calculate the entire topic calculated based on all the chats performed after the chat windows are opened on the instant messenger, and topics by period calculated based on the chats performed during a specific time range (e.g., one day). Further, the context-based selection unit 131b may determine whether the chat topic has been changed and the changed chat topic based on the list of major words used in real time.

The context-based selection unit 131b may perform an operation of selecting the advertisements related to the topic based on the determined chat topic. The context-based selection unit 131b may select an advertisement field related to the calculated topic, and may select advertisements of individual items belonging to the selected advertisement field as a possible advertisement history.

For example, when two or more persons are in chat for setting an appointment place in a group chat room belonging to chat participants, the context-based selection unit 131b monitors the chat history, then determines the chat topic, and may select advertisements such as restaurant, hotel, accommodation reservation site and the like corresponding to a ‘meeting place’ which is the determined chat topic.

The context-based selection unit 131b may perform an operation of analyzing a chat-based chat history, not a user-based chat history. Accordingly, the context-based selection unit 131b may analyze interest information in a community unit to which the user belongs, not the individual user.

At this time, the context-based selection unit 131b may set a standard range for a percentage of a specific topic in the chats, and may determine whether a ratio of the used words and sentences corresponding to the specific topic is within the standard range. If the ratio of the used words and sentences corresponding to the specific topic exceeds the standard range, the context-based selection unit 131b may designate a specific property value of the chat window. For example, the context-based selection unit 131b may be set so that the standard range which may be referred to in a general chat with respect to the specific topic such as childcare, climbing, study, meeting, etc., has a value less than 10% of the entire chats. In this case, if the specific topic (for example, climbing) performed in a specific chat window is out of the standard range, the context-based selection unit 131b may designate the specific property value (for example, assign a code corresponding to ‘climbing’) for the chat window. Accordingly, when the first user inputs a chat message in the chat window in which the specific property value is designated, the context-based selection unit 132b may select the related product advertisement corresponding to the assigned property value (a topic code) as an advertisement to be transmitted through the chat message input by the first user.

The context-based selection unit 131b may select the advertisement items and the advertisement contents corresponding to the common chat topic and interests of the chat participants. In such a case, the present invention may advertise the items corresponding to the common interests of the first user and the second user by transmitting advertisement message one time, thereby encouraging both the first user and the second user to make purchases.

The user preference-based selection unit 131c may perform an operation of selecting the advertisement corresponding to a preference item which is previously selected by the user as an advertisement to be provided. According to various embodiments of the present invention, the user preference-based selection unit 131c may obtain information on the preference item from the user. Herein, the obtained user preference items may include user preference information on at least one of a user-preferred specific advertisement image, a user-preferred specific advertisement moving picture, a user-preferred specific advertisement item, a user-preferred specific brand, and a user-preferred specific advertisement model. On the basis of the user preference information, the user preference-based selection unit 131c may assign priorities to the advertisements corresponding to the items preferred by the user.

FIG. 4 is a block diagram illustrating a detailed configuration of the reward management unit according to the embodiment of the present invention.

As illustrated in FIG. 4, the reward management unit 133 according to the embodiment of the present invention may include an advertisement viewing check unit 133a, a weight setting unit 133b, and a reward providing unit 133c.

The advertisement viewing check unit 133a may check advertisement viewing information of the user in order to determine whether the user satisfies a reference for obtaining the reward in the reward advertisement. The advertisement viewing check unit 133a may check whether the user has accessed the advertisement image and reproduced the advertisement, the time of reproducing the advertisement image, whether the operation requested by the advertisement image is performed (e.g., membership registration, record of contact address, application download, etc.) and the like. Further, the advertisement viewing check unit 133a may check the number of times of viewing the advertisement.

The advertisement viewing check unit 133a may record the history of browsing the advertisement contents on the transaction of the cryptocurrency by the block chain. Accordingly, even if the browsed advertisement content is browsed in other chat rooms or browsing it after a predetermined time elapses, the total number of times of browsing the advertisement by the user may be calculated.

The weight setting unit 133b may calculate a reward to be provided based on the advertisement viewing information of the user, which is confirmed by the advertisement viewing check unit 133a, and may calculate the reward by applying a weight. If the number of times of viewing the advertisement by the user exceeds the preset number of times, the weight setting unit 133b may apply the weight to the reward at the time of calculating. In addition, when the second user who received the advertisement accesses the link included in the advertisement and purchases the advertisement article, the weight setting unit 133b may apply the weight to the reward at the time of calculating the reward. At this time, the weight setting unit 133b may apply the weight to the reward of the first user who provided the advertisement to the second user.

The reward providing unit 133c may perform an operation of calculating a reward to be provided to the user corresponding to information on the result checked by the advertisement viewing check unit 133a, and an operation of providing the calculated reward. In addition, the reward providing unit 133c may provide the reward corresponding to the result calculated by the weight setting unit 133b.

The reward providing unit 133c may also select a method of providing the reward. The reward providing unit 133c may select a method for providing the reward among methods such as arbitrary providing, providing upon satisfying the reference for obtaining the reward and the like. The reward providing unit 133c may also select the type of the reward. According to various embodiments, the type of reward may include mobile money, blockchain-based cryptocurrency and the like.

The reward providing unit 133c may also transmit a reward notification message for notifying that the reward has been provided to a subject who is to receive the reward.

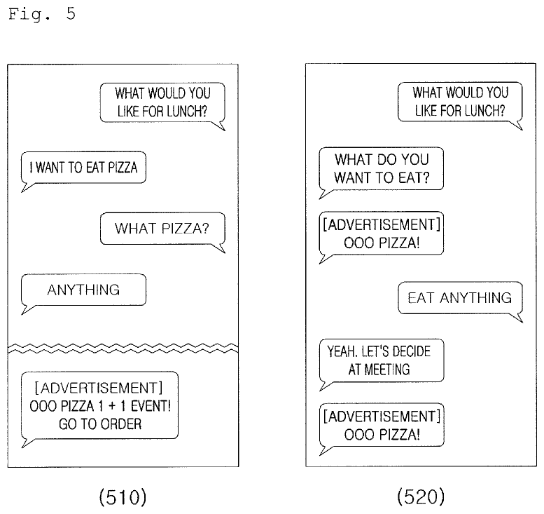

FIG. 5 is a diagram illustrating chat windows of the reward advertisement performed on the instant messengers according to the embodiment of the present invention.

FIG. 5 illustrates an image in which two users chat in a chat window 510. The chat window 510 illustrates a case in which an advertisement is transmitted from the first user to the second user according to a specific condition with being included in a message. In addition, the chat window 510 illustrates an image in which the reward advertisement performed on the instant messenger is provided in a state in which the chat of the chat participants is temporarily stopped.

According to the embodiment of the present invention, the conditions under which the advertisement contents are transmitted from the first user to the second user may include the number of times of message transmission/reception (for example, the number of times of message transmission/reception is four times or more), chat time (e.g., 3 minutes or more), whether the chat interrupts (e.g., one minute elapses after the interruption) and the like. The chat window 510 illustrates an example in which the advertisement content is transmitted according to the determination that the chat has been interrupted for a predetermined time or more.

Further, FIG. 5 illustrates a case in which all the messages transmitted to the second user by the first user are provided together with an advertisement in a chat window 520. Various embodiments of the present invention may control the first user terminal so as to transmit all messages transmitted to the second user by the first user by including the advertisement, without any additional condition as illustrated in the chat window 520.

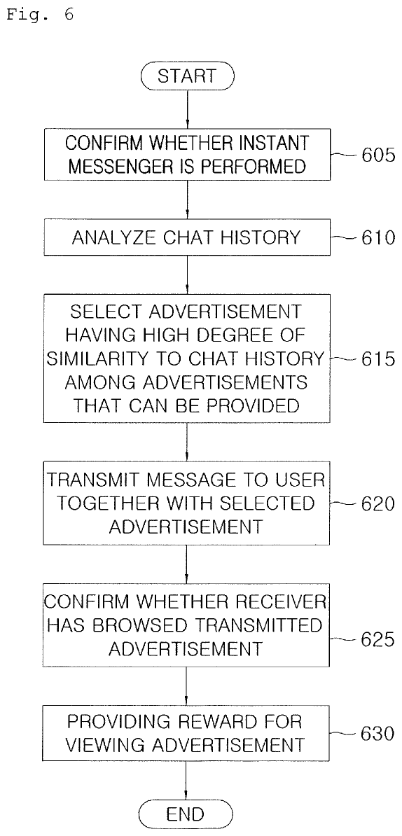

FIG. 6 is a flowchart illustrating a procedure of advertisement and reward providing operations according to the embodiment of the present invention.

As illustrated in FIG. 6, the controller 130 of the messenger advertisement providing server 10 according to the embodiment of the present invention may perform an operation 605 of confirming whether the instant messenger of the first user is performed. Thereafter, the controller 130 may perform an operation 610 of analyzing chats performed by the first user with other users using the instant messenger. The analysis operation may include, for example, extracting words included in the messages of the first user and other users (the second user) who are in chat with the first user. At this time, the word extracted by the controller 130 may be a word related to the classification of the advertisement that may be provided by the messenger advertisement providing server 10. For example, the extracted word may be a word corresponding to a large classification such as ‘cosmetics,’ ‘clothing,’ ‘books,’ and ‘movies.’ In addition, the extracted words in addition thereto may include a specific product name. According to various embodiments, the controller 130 may extract all the words included in the chat history.

Thereafter, the controller 130 may perform an operation 615 of selecting an advertisement having a high degree of similarity to the chat history among the advertisements that can be provided. The controller 130 may obtain chat messages performed between the first user and the second user on the instant messengers in order to determine the degree of similarity between the chat history and the advertisement items, and perform an operation of processing sentences included in the chat in a natural language. Accordingly, the controller 130 may perform an operation of determining whether the user is interested in purchasing a specific item. The controller 130 may determine whether the user's evaluation type for a specific word extracted based on the contents of the chat message is a positive evaluation or a negative evaluation. In addition, when the negative evaluation is calculated to be higher than the positive evaluation, the controller 130 may determine that the user's intention to purchase the article related to the word is low. Accordingly, the degree of similarity may be evaluated as a low value. For example, even if the word ‘book’ is extracted from the chat history, and as a result of processing contents of a sentence including the word ‘book,’ when the negative evaluation is calculated to be higher than the positive evaluation, the controller 130 may evaluate the degree of similarity between the chat history and the ‘book,’ and set the priority of the book related advertisement to be low.

In addition, the controller 130 may calculate the area of interest of the chat participants based on the chat history. For example, the controller 130 may calculate a ranking of the items that best matches the area of interests of the chat participants among the preset interest area items. The controller 130 may calculate the interests of the chat participants based on the words included in the chat history, the number of times of inputting the specific word and the like. The area of interest may be previously set as a large classification item such as, for example, ‘travel,’ ‘clothing,’ ‘beauty,’ ‘electronic device,’ or ‘cultural life.’ After extracting the words included in the chat history, when properties of the extracted words are words included in a small classification item, it is possible to calculate words of a middle classification or a large classification including the extracted words, and classify the words based on the calculated results. The user interest extraction unit 131 may extract the interests of the chat participants based on the chat history of the chat participants through this process. For example, if the word ‘leggings’ is obtained in the chat history, the controller 130 may classify the word ‘leggings’ into the ‘clothing’ item, which is an upper level classification item. The controller 130 may determine the area corresponding to the large classification item in which the largest number of words is secured through the item classification operation of the words as an area of user's interest. For example, the controller 130 performs an operation of extracting and classifying the words based on the chat history of the user, and as a result thereof, if it is assumed that result values are calculated as one (1) in the travel item, ten (10) in the clothing item, two (2) in the beauty item, and zero (0) in the electronic device and cultural life item, the controller 130 may determine that the interest of the user is the ‘clothing’ item.

If the interests of the chat participants are extracted based on the chat history, the controller 130 may also perform an operation of searching for a specific advertisement target article by associating interests with the words obtained in the chat history. For example, if a word in a list detected the preset number or more of times among the detected words in the chat history is ‘leggings’ and the previously calculated area of user's usual interests is ‘exercise,’ the controller 130 may perform an operation of circulating the leggings for exercise among the ‘leggings’ as an advertisement target article. In this way, the controller 130 may select a specific advertisement target article by combining the specific words detected the preset number or more of times in the chat history and information on the area of user's usual interests.

Then, the controller 130 may perform an operation 620 of controlling so as to transmit the message to the other users (the second user) by the user (the first user) together with the selected advertisement. At this time, the condition for performing the operation 620 by the controller may be variously set. For example, if it is determined that the chat through the instant messenger is continued for a preset time (e.g., three minutes) or more, the controller 130 performs an operation 620 in a situation in which the transmission of the advertisement is approved by the first user.

Thereafter, the controller 130 may perform an operation 625 of confirming whether the receiver has browsed the transmitted advertisement. For example, when the receiver (second user) confirms the user message, the controller 130 may determine that the advertisement text or the advertisement image included in the message is browsed. In addition, if it is determined that the second user has performed downloading or registering according to the instruction of the transmitted advertisement, the controller 130 may determine that the advertisement is browsed.

After the operation 625, the controller 130 may perform an operation 630 of providing a reward for viewing the advertisement to at least one of the first user and the second user. At this time, the reward may include various forms. For example, the reward may include a blockchain-based cryptocurrency, a gift certificate that can purchase the advertised product and the like.

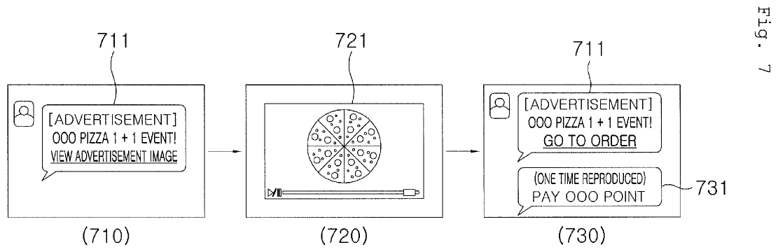

FIG. 7 is a diagram illustrating an operation of providing a reward according to the embodiment of the present invention.

FIG. 7 illustrates an operation of displaying an advertisement message 711 by the first user in an instant message chat window 710. In this way, the messenger advertisement providing server 10 according to the embodiment of the present invention may control the first user terminal 20 so as to display a message including the advertisement contents in the chat window on the instant messenger through an account of the first user. In addition, the advertisement message 711 may include link information for reproducing the advertisement content (e.g., advertisement image). The chat participants may select the link information in the advertisement message to access a webpage for reproducing the advertisement image. A chat window 720 illustrates a state in which an advertisement image 721 is reproduced by selecting the link information in the advertisement message. The messenger advertisement providing server 10 may control so as to display a reward notification message 731 that notifies a reward payment as illustrated in a chat window 730 when viewing the advertisement is completed by the user as illustrated in the chat window 720.

According to various embodiments, the first user, who is the subject of displaying the advertisement message in the chat window, may reproduce the advertisement, such that the messenger advertisement providing server 10 may pay a reward to the first user who viewed the advertisement. On the other hand, when the second user of the subject who has received the advertisement message reproduces the advertisement, the messenger advertisement providing server 10 may pay a reward to the second user. However, if the account or the like enabling the second user to receive the reward is not registered in the messenger advertisement providing server 10, when it is confirmed that the second user has viewed the advertisement, the messenger advertisement providing server 10 may additionally display a notification screen requesting application installation, membership registration, and the like, which are required to provide the reward.

While the present invention has been described in detail with reference to the above-described embodiments, it should be understood by those skilled in the art that various changes, modifications, and alternations for the present embodiments may be made without departing from the spirit and scope of the invention. To sum up, it should be also understood that it is not necessary to include all functional blocks illustrated in the drawings or to follow all sequences illustrated in the drawings as the sequences illustrated in order to achieve the effects intended by the present invention, and it should be also understood that all technical ideas within the equivalent scope belong to the technical scope of the present invention described in claims.

1. An advertisement and reward system based on an instant messenger, the system comprising:
a first user terminal configured to transmit a message to a second user terminal side on the instant messenger, wherein the message is transmitted under a control of a messenger advertisement providing server and includes an advertisement;
the second user terminal configured to receive the message including the advertisement from the first user terminal, and perform the advertisement included in the received message; and
the messenger advertisement providing server configured to control the first user terminal so as to transmit the message created in the first user terminal with the advertisement included therein, and if it is confirmed that the advertisement has been executed, provide a reward to at least one of the first user terminal and the second user terminal,
wherein the reward includes a blockchain-based cryptocurrency.

2. The system according to claim 1, wherein the messenger advertisement providing server comprises a controller, and the controller comprises:
an optimal advertisement selection unit configured to, when selecting an advertisement to be provided through the message of the first user, select an advertisement which is determined to be suitable for providing by the first user terminal among the advertisements to be provided by the messenger advertisement server, based on a chat history of the first user;
an advertisement transmission unit configured to control the first user terminal so as to transmit the advertisement selected by the optimal advertisement selection unit to the second user terminal with being included in a chat message on the instant messenger transmitted from the first user terminal; and
a reward management unit configured to provide a reward to a user who viewed the advertisement transmitted with being included in the chat message, and transmit a reward notification message for notifying that the reward has been provided to a subject who is to receive the reward.

3. The system according to claim 2, wherein the optimal advertisement selection unit comprises:
a user interest extraction unit configured to extract interests of the user based on the chat history of the user performed on the instant messenger by extracting words included in the chat message, then perform an operation of classifying the extracted words into items, and determine a ranking of the interests of the user in descending order from a field having the largest number of the words contained in the message;
a context-based selection unit configured to calculate a chat topic based on the chat history performed after chat windows are opened on the instant messenger, and select an advertisement related to the calculated chat topic when selecting an advertisement to be provided through the message of the first user; and
a user preference-based selection unit configured to select the advertisement to be provided through the message of the first user based on user preference information including at least one of an advertisement image, an advertisement moving picture, an advertisement item, a brand, and an advertisement model, which are preferred by the user.

4. The system according to claim 3, wherein the context-based selection unit sets a standard range for a percentage of words and sentences of a specific topic in chats of the chat window, and when the percentage is the standard range or more, assign a topic code to the chat window, then select a product advertisement corresponding to the topic code when selecting the advertisement.

5. The system according to claim 2, wherein the advertisement transmission unit transmits advertisement contents with being included in the message when satisfying an advertisement transmission condition, and
the advertisement transmission condition includes at least one of the cumulative number of chat messages in a day, a reference time elapsed from a chat start time, and a reference time elapsed from a chat stop time.

6. The system according to claim 2, wherein the reward management unit comprises:
an advertisement viewing check unit configured to confirm at least one of whether the advertisement is reproduced by the user, the time of reproducing the advertisement, whether an operation requested by the advertisement image is performed, and the number of times of viewing the advertisement; and
a reward providing unit configured to calculate a reward value to be provided corresponding to a result value confirmed by the advertisement viewing check unit, and provide the calculated reward value to at least one of the first user terminal and the second user terminal, wherein the reward value is provided in methods including arbitrary providing, and providing upon satisfying a reference for obtaining the reward.

7. The system according to claim 2, wherein the reward management unit comprises:
a weight setting unit configured to, when the second user who received the advertisement accesses a link included in the advertisement and purchases an advertisement article, apply a weight to the reward of the first user who provided the advertisement to the second user.
